(19) United States
(12) Patent Application Publication
(10) Pub. No.: US 2017/0323568 A1
(43) Pub. Date: Nov. 9, 2017

(54) RISK PREDICTION DEVICE AND DRIVING SUPPORT SYSTEM

(71) Applicants: DENSO CORPORATION, Kariya-city, Aichi-pref. (JP); TOHOKU UNIVERSITY, Sendai-shi, Miyagi (JP)

(72) Inventors: Naoya Inoue, Kariya-city, Aichi-pref. (JP); Eiichi Okuno, Kariya-city, Aichi-pref. (JP); Katsunori Abe, Kariya-city, Aichi-pref. (JP); Toshiyuki Kondoh, Kariya-city, Aichi-pref. (JP); Yasutaka Kuriya, Kariya-city, Aichi-pref. (JP); Kentaro Inui, Sendai-city (JP)

(21) Appl. No.: 15/522,625

(22) PCT Filed: Oct. 19, 2015
(86) PCT No.: PCT/JP2015/005261

§ 371 Date: Apr. 27, 2017

(30) Foreign Application Priority Data
Oct. 29, 2014 (JP) 2014-220329

(51) Int. Cl. G08G 1/16; B60W 30/095

(52) U.S. Cl. CPC G08G 1/163; B60W 30/0956; G08G 1/166; G08G 1/165

(57) ABSTRACT

A vehicular information display apparatus is provided which includes a display apparatus provided in a vehicle compartment and a display controller for controlling display of the display apparatus and is arranged to display specific information about a vehicle in a form to include a graphic on a screen of the display apparatus. The vehicular information display apparatus switches between a first display mode in which the specific information is displayed on a display region in the screen of the display apparatus and a second display mode in which the specific information is displayed on a display region smaller than the first display mode in the screen of the display apparatus. The display controller displays the graphic of the specific information by changing an orientation or a shape of the graphic when the display region is changed.

### CROSS-REFERENCE TO RELATED APPLICATIONS

The present application is based on Japanese Patent Application No. 2014-220329 filed on Oct. 29, 2014, disclosure of which is incorporated herein by reference.

### TECHNICAL FIELD

The present disclosure relates to a technology based on hypothetical reasoning for predicting possible risks during vehicle driving.

### BACKGROUND ART

Studies were conducted to develop a technology for sensing the surroundings of a vehicle with, for example, an image sensor, determining a risk in a traffic scene based on the result of sensing, and warning a vehicle driver of the determined risk.

For example, it is determined whether the presence of a risk predetermined by a logical expression is provable from the logical expression indicative of a sensing result by using a knowledge base, which is a set of rules obtained by defining, for example, general knowledge according to the logical expression. A known technology is available to output the proved risk as well as a risk level preassigned to the proved risk (refer to Patent Literature 1).

### PRIOR ART LITERATURE

### Non-Patent Literature

Non-Patent Literature 1: Andreas D. Lattner, Ingo J. Timm, Martin Lorentz, and Ottehein Herzog, “Knowledge-based Risk Assessment for Intelligent Vehicles”, KIMAS 2005.

### SUMMARY OF INVENTION

However, when the prior art technology is used, the outputted risk level merely depends on the type of risk to be predicted and may be considerably different from an actual risk level.

That is, the result of detection of the surroundings (observed information) is used as an evidence in a proof process. However, the prior art technology gave no consideration to the reliability of the observed information and the details of the proof process. Therefore, no matter whether the outputted risk level is proved by far-fetched reasoning insufficiently supported by the observed information or proved by reasoning sufficiently supported by the observed information, the risk level remains the same when proved risks are of the same type.

If a proved risk indicates the possibility of a child rushing out of a blind spot when the acquired observed information indicates “a ball in the vicinity of the blind spot” or indicates “the blind spot” but does not indicate “the presence of the ball”, the vehicle driver should feel a relatively high risk level in the former case where an increased amount of observed information is acquired. However, when the prior art technology is used, the risk level remains unchanged no matter whether the former case or the latter case is encountered.

In view of the above circumstances, an object of the present disclosure is to provide a technology that achieves accurate risk prediction based on the surroundings.

A risk prediction device in an example of the present disclosure comprises an observed information acquisition section, a logical expression conversion section, a hypothetical reasoning section, and a reasoning result interpretation section.

The observed information acquisition section acquires observed information about surroundings of a vehicle. The logical expression conversion section converts the observed information acquired by the observed information acquisition section to a logical expression indicative of the surroundings of the vehicle. The hypothetical reasoning section, using a knowledge base, proves a risk predicted by weighted hypothetical reasoning from the logical expression obtained from conversion by the logical expression conversion section as a proof target, the knowledge base being a set of rules that are written in logical expression form to describe risks encountered during vehicle driving and general knowledge. The reasoning result interpretation section determines a risk level of the proved risk from a proof cost determined during reasoning by the hypothetical reasoning section, and associates the logical expression used for proof with the observed information.

The above-described configuration not only determines the presence of a risk by hypothetical reasoning, but also determines the proof cost indicative of the quality of the proof and determines the risk level of the proved risk from the determined proof cost. Therefore, the quality of the proof, namely, an evidence (observed information) to be applied to the proof and the reliability of the rules, can be reflected in the risk level. Consequently, accurate prediction can be achieved based on the surroundings.

A driving support system in an aspect of the present disclosure comprises the above-mentioned risk prediction device and a support execution device. The support execution device executes a driving support process in order to cope with a risk proved by the risk prediction device.

The above-described configuration implements a highly reliable driving support process.

### BRIEF DESCRIPTION OF DRAWINGS

The above and other objects, features, and advantages of the present disclosure will become more apparent from the following detailed description made with reference to the accompanying drawings. In the drawings:

FIG. 1 is a block diagram illustrating a configuration of a driving support system;

FIG. 2 is a flowchart illustrating a process executed by a logical expression conversion section;

FIG. 3(a) is a diagram illustrating the relationship between a recognized object and a logical constant, and FIG. 3(b) is a diagram illustrating rules of converting observed information to a logical expression;

FIG. 4 is a diagram illustrating exemplary costs attached to observed literals;

FIGS. 5(a) to 5(c) are diagrams illustrating the contents of knowledge bases, in which FIG. 5(a) illustrates an intention estimation knowledge base, FIG. 5(b) illustrates a natural law knowledge base, and FIG. 5(c) illustrates a risk factor knowledge base;

FIG. 6 is a flowchart illustrating a process executed by a hypothetical reasoning section according to a first embodiment of the present disclosure;

FIG. 7 is a diagram illustrating a concrete example of a driving scene and observed information extracted from the driving scene;

FIG. 8(a) is a diagram illustrating the relationship between a proof candidate and a driving scene where a blind spot and a ball are recognized, and

FIG. 8(b) is a diagram illustrating a proof procedure and a proof cost calculation method;

FIG. 9(a) is a diagram illustrating the relationship between a proof candidate and a driving scene where a blind spot is recognized, and FIG. 9(b) is a diagram illustrating a proof procedure and a proof cost calculation method;

FIG. 10(a) is a diagram illustrating the relationship between a proof candidate and a driving scene where a blind spot and a ball-like object are recognized, and FIG. 10(b) is a diagram illustrating a proof procedure and a proof cost calculation method;

FIG. 11 is a flowchart illustrating a process executed by the hypothetical reasoning section according to a second embodiment of the present disclosure;

FIG. 12(a) is a diagram illustrating a driving scene and observed information extracted from the driving scene, and FIG. 12(b) is a diagram illustrating a proof procedure;

FIG. 13 is a flowchart illustrating a process executed by the hypothetical reasoning section and physics calculation section according to a third embodiment of the present disclosure;

FIG. 14(a) is a diagram illustrating a situation targeted for hypothetical reasoning, and FIG. 14(b) is a diagram illustrating the result of path calculation by the physics calculation section and the result of hypothetical reasoning and is an example in which the result produced by the physics calculation section affects the result of hypothetical reasoning; and

FIG. 15(a) is a diagram illustrating a situation targeted for hypothetical reasoning, and FIG. 15(b) is a diagram illustrating the result of path calculation by the physics calculation section and the result of hypothetical reasoning and is an example in which the result produced by the physics calculation section does not affect the result of hypothetical reasoning.

### DESCRIPTION OF EMBODIMENTS

Embodiments of the present disclosure will now be described with reference to the accompanying drawings.

### 1. First Embodiment

### 1.1. Overall Configuration

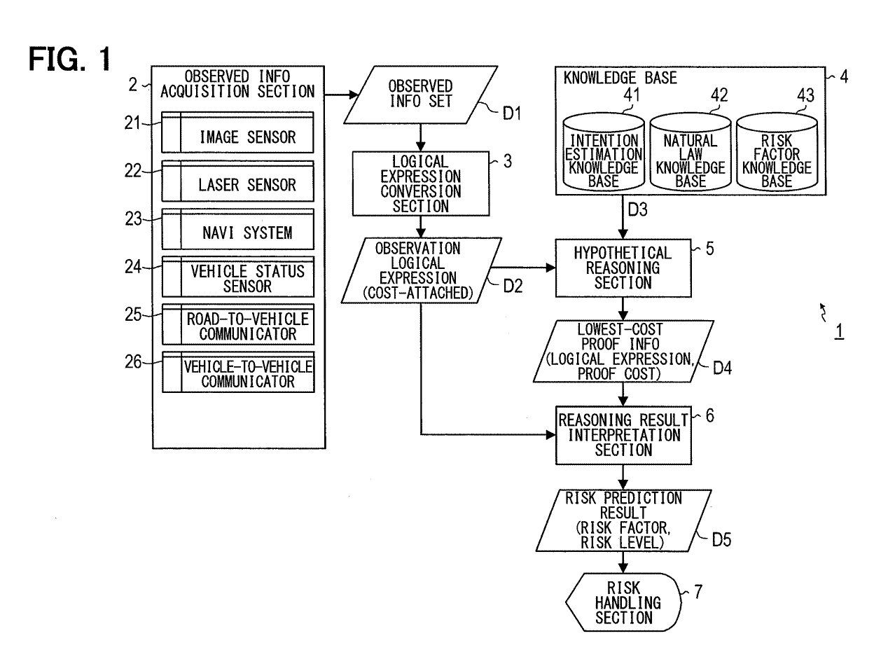

A driving support system 1 illustrated in FIG. 1 includes an observed information acquisition section 2, a logical expression conversion section 3, a knowledge base 4, a hypothetical reasoning section 5, a reasoning result interpretation section 6, and a risk handling section 7. At least the logical expression conversion section 3, the hypothetical reasoning section 5, and the reasoning result interpretation section 6 are implemented by processes executed by microcomputers (not shown) that are mainly formed of a CPU, a ROM, and a RAM.

### 1.2. Observed Information Acquisition Section

The observed information acquisition section 2 detects the behavior and status of a vehicle. Based on information acquired from an image sensor 21, a laser sensor 22, a navigation system 23, vehicle status sensors 24, a road-to-vehicle communicator 25, and a vehicle-to-vehicle communicator 26, the observed information acquisition section 2 observes the status of the vehicle and the surroundings of the vehicle and generates observed information about objects existing around the vehicle. A set of the observed information about the objects will be hereinafter referred to as the observed information set D1.

Information about the behavior of the vehicle and the status of the vehicle is acquired from the vehicle status sensors 24. Results of detection by the image sensor 21 and the laser sensor 22 are processed to acquire information about various objects around a subject vehicle. Information about traffic congestion and traffic restrictions is acquired from the road-to-vehicle communicator 25 through an infrastructure, which is a communication partner. Information about the behavior of a different vehicle is acquired from the vehicle-to-vehicle communicator 26. Various information derived from map information about the current position of the subject vehicle and an area around the current position is acquired from the navigation system 23.

The observed information generated from the above information includes at least information about an object type, object attributes, and information reliability. For example, the object attributes of a movable object include its position, moving speed, and moving direction. The object attributes of a human object may include information about gender, adult/child, and personal belongings. Information about reliability may be acquired by using a technology disclosed in JP2008-26997, which is incorporated herein by reference.

### 1.3. Logical Expression Conversion Section

The logical expression conversion section 3 receives the observed information set D1 generated by the observed information acquisition section 2, and converts the observed information set D1 to a logical expression. A literal forming the logical expression is hereinafter represented by Li. However, i is an identifier expressed by a positive integer. The literal is a logical expression having no partial logical expression. A cost is attached to each literal. The cost is a value that is set based on the reliability of the literal, that is, eventually based on the observation reliability, which is the source of literal generation. The cost is represented by ci. Here, the cost ci is variable from 1 to 100 and set to a value that is inversely proportional to the reliability. That is, when the cost ci=1, a condition expressed by the literal Li is to be surely established, that is, the reliability is 100%. Meanwhile, when the cost ci=100, whether the condition expressed by the literal Li is to be established is completely unknown, that is, the reliability is 0%. A literal with a cost is hereinafter represented by Li^{$ci}.

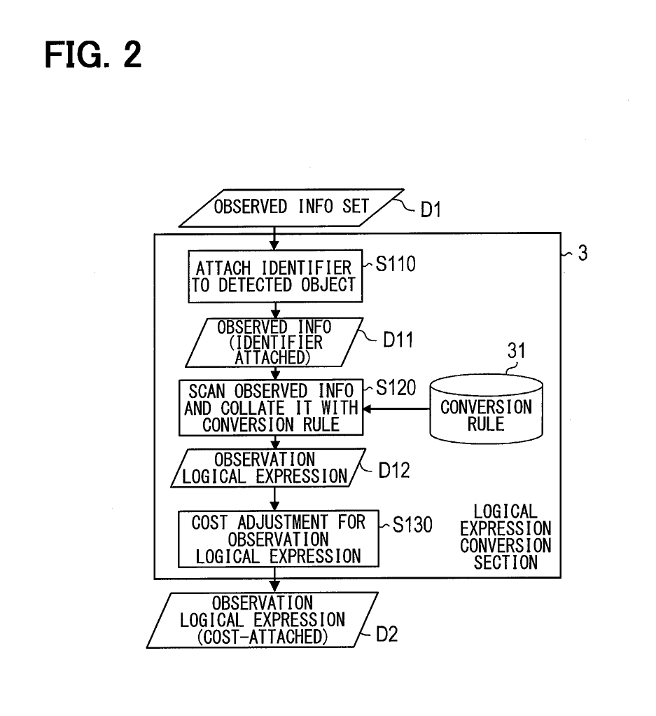

A logical expression conversion process will now be described in detail with reference to the flowchart of FIG. 2.

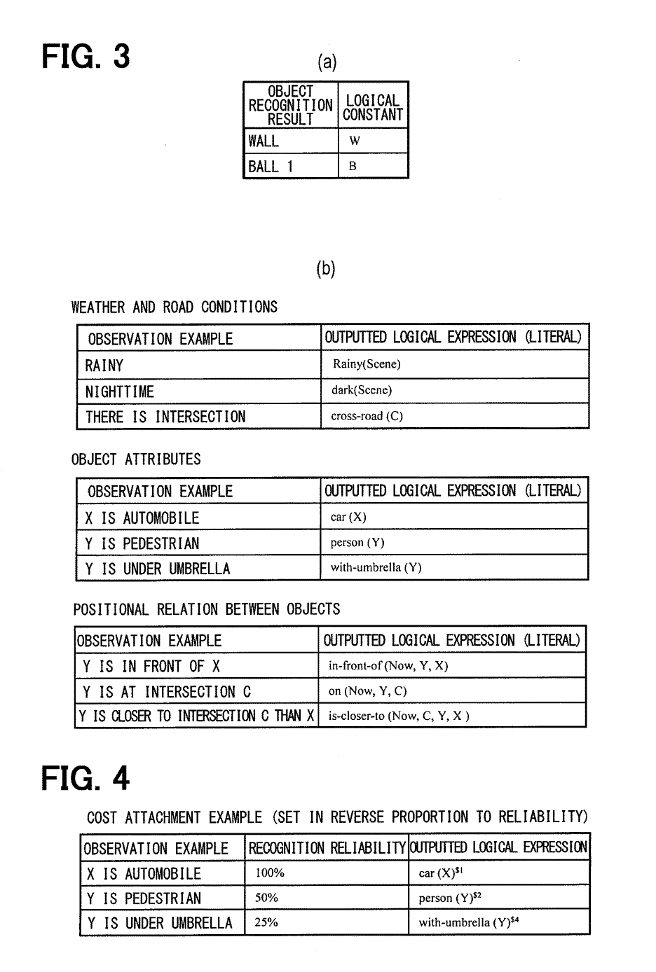

First of all, a microcomputer functioning as the logical expression conversion section 3 (hereinafter referred to as the “conversion microcomputer”) generates an identifier-attached observed information set D11 by attaching an identifier for object identification to each observed information forming the observed information set D1 (S110). As illustrated in FIG. 3(a), a logical constant formed, for example, of an alphabetical character is used as the identifier.

Next, the conversion microcomputer collates the observed information, which forms the identifier-attached observed information set D11, with a prepared conversion rule 31, converts the observed information to literals Li, and uniformly sets the cost of each literal Li to 1 (ci=1). The conversion microcomputer then generates an observation logical expression D12 (S120). The observation logical expression D12 is a logical expression that is obtained by ANDing (Λ) the cost-attached literals.

As illustrated in FIG. 3(b), various conversion rules are available including those related to weather and road conditions (e.g., rainy, nighttime, there is an intersection), those related to object attributes (the object X is an automobile, the object Y is a pedestrian, the object Y is under an umbrella), and those related to the positional relationship between objects (Y is in front of X, Y is at an intersection C, Y is closer to an intersection C than X).

Returning to FIG. 2, the conversion microcomputer adjusts the cost ci based on the recognition reliability of observed information from which each cost-attached literal Li^{$ci} forming the observation logical expression D12 is generated as illustrated in FIG. 4, and outputs the result of the adjustment as a cost-attached observation logical expression D2 (S130).

### 1.4. Knowledge Base

The knowledge base 4 is a collection of general knowledge that is expressed by logical expressions. The knowledge base 4 includes an intention estimation knowledge base 41, a natural law knowledge base 42, and a risk factor knowledge base 43.

The contents of each knowledge base 41-43 are expressed by a logical expression formed as indicated in Expression (1) while Aj and C are regarded as literals and wj is regarded as the weight of the literal Aj.

[Mathematical 1]

A1^{w1} [symbol] A1^{w2} [symbol] . . . [symbol] An^{wn}→C (1)

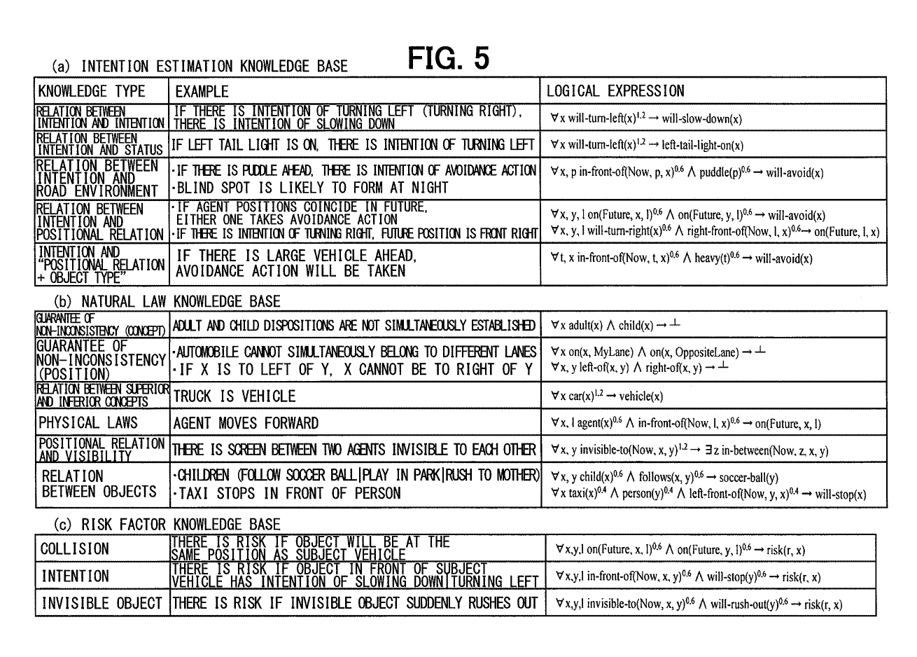

The intention estimation knowledge base 41 is written in predicate logic form to describe the relationship between a vehicle driver's intention, vehicle status, road environment, and the position of a detected object. As indicated at FIG. 5(a), a logical expression is used to represent the contents, such as “if there is an intention of turning left, there is an intention of slowing down”, “if the left tail light is on, there is an intention of turning left”, and “if there is a large vehicle ahead, an avoidance action will be taken”.

The natural law knowledge base 42 describes the contradictory relationship between physical laws and concepts and the relationship between objects. For example, as indicated at FIG. 5(b), a logical expression is used to represent the contents, such as “adult and child dispositions do not simultaneously exist”, “automobiles cannot simultaneously belong to different lanes”, and “children follow a soccer ball”.

The risk factor knowledge base 43 describes patterns of risky surroundings and is represented by a logical expression having a “risk” consequent part. As indicated at FIG. 5(c), a logical expression is used to represent the contents, such as “if a different object will be at the same position as the subject vehicle, there is a risk”, “if an object having an intention of slowing down and turning left is in front of the subject vehicle, there is a risk”, and “if a hidden object rushes out, there is a risk”.

The logical expressions to be stored in the knowledge base 4 may be manually generated or automatically acquired, for example, from a database of webs and accidents by using a well-known text mining technology. The weight wj of the literal Aj may be manually given or automatically given by using, for example, a well-known teacher-aided machine learning method (e.g., Kazeto Yamamoto, Naoya Inoue, Youtaro Watanabe, Naoaki Okazaki, and Kentaro Inui, “Backpropagation Learning for Weighted Abduction”, Research Report of Information Processing Society of Japan, Vol. 2012-NL-206, May 1012, which is incorporated herein by reference).

### 1.5. Examples of Predicates Used in Logical Expression

Examples of literals obtained as a result of conversion from the observed information set D1 and examples of literals used to describe the contents of the knowledge base 4 (logical expressions) are enumerated below. The literals may express, for example, the type of an object, the status of an object, the intention of an object, the positional relationship between objects, the semantic relationship between objects, or road conditions.

The literals indicating the type of an object are, for example, an adult (adult), an agent (agent), a dangerous agent (dangerous-agent), a dog (dog), an elder (elder), a child (child), children (children), a person (person), a group of children (group-of-children), a group of persons (group-of-persons), a pedestrian (ambulance), a bicycle (bicycle), a bus (bus), a vehicle (car), a group of cars (group-of-cars), a motorcycle (motor-bicycle), an automobile (motor-cycle), a tank or a track (tank-truck), a taxi (taxi), a van (van), a vehicle (vehicle), an alley (alley), an apartment (apartment), a break (break), a building (building), a bridge (bridge), a cone (cone), a gate (gate), a park (park), a wall (wall), a crossroad (cross-road), a crosswalk (cross-walk), a curve (curve), a descent (descent), a lane (lane), an intersection (intersection), a railroad crossing (railroad-crossing), a traffic light (signal), a pedestrian traffic light (signal4walker), a safety zone (safety-zone), a dangerous spot (dangerous-spot), a manhole (biscuit), a soccer ball (soccer-ball), a thing (thing), an iron plate (iron-plate), a leaf (leaf), a light (light), a load (load), an obstacle (obstacle), a screen (screen), a puddle (puddle), and a sandy spot (sandy-spot).

The literals indicating the status of an object are, for example, left head lamp on (left-head-lamp-on), left tail light on (left-tail-light-on), right head lamp on (right-head-lamp-on), right tail light on (right-tail-light-on), being parked (being-parked), empty (empty), green light on (signal-blue), green light blinking (signal-blue-blink), yellow light on (signal-yellow), nothing above (nothing-on), parked (parked), invisible (invisible-to), visible (visible-to), waving hands (waving-hands), and wheel stuck (wheel-drop).

The predicates indicating the intention of an agent are, for example, will cross (will-across), will avoid (will-avoid), will be out of lane (will-be-out-of-lane), will change direction (will-change-direction), will change lanes (will-change-lane), will traverse (will-cross), will give way (will-give-way), will go backward (will-go-back), will go forward (will-go-front), will go left (will-go-left), will go right (will-go-right), will move to front (will-move-front-side), will open door (will-open-door), will open left door (will-open-left-door), will overtake (will-overtake), will rush out (will-rush-out), will slow down (will-slow-down), will speed up (will-speed-up), will splash water and mud (will-splash), will stay (will-stay), and will stop (will-stop).

The literals indicating the positional relationship between objects are, for example, around (around), behind (behind), rear left of (left-behind), front left of (left-front-of), left of (left-of), not in front of (not-in-front-of), not front left of (not-left-front-of), not left of (not-left-of), rear right of (right-behind), front right of (right-front-of), right of (right-of), lateral side of (side-front-of), front side of (front-side-of), in between (in-between), in front of (in-front-of), is closer to (is-closer-to), vehicle closest to (is-closest-vehicle-to), on (on), catch (catch), and contact (contact).

The literals indicating the semantic relationship between objects are, for example, belong to (belongs-to), have (has), keep (keep), source of (mother-of), play at (plays-at), follow (follows), ride on (ride-on), and heavier than (heavier-than).

The literals indicating the road conditions are, for example, environment (environment), facility (facility), construction site (construction-site), rainy (rainy), wet (wet), icy (icy), muddy (muddy), dark (dark), snowy (snowy), and straight road (straight).

### 1.6. Hypothetical Reasoning Section

Based on an observation logical expression D2 obtained from conversion by the logical expression conversion section 3 and a logical expression stored in the knowledge base 4 (hereinafter referred to as the “knowledge logical expression D3”), the hypothetical reasoning section 5 executes a hypothetical reasoning process on a risky situation. Here, the knowledge logical expression D3, which serves as background knowledge, is used to prove a risk predicted from the observation logical expression D2. Weighted hypothetical reasoning (refer to Hobbs, Jerry R., Mark Stickel, Douglas Appelt, and Paul Martin, 1993, “Interpretation as Abduction”, Artificial Intelligence, Vol. 63, Nos. 1-2, pp. 69-142, which is incorporated herein by reference) is performed here to obtain a maximum-likelihood proof.

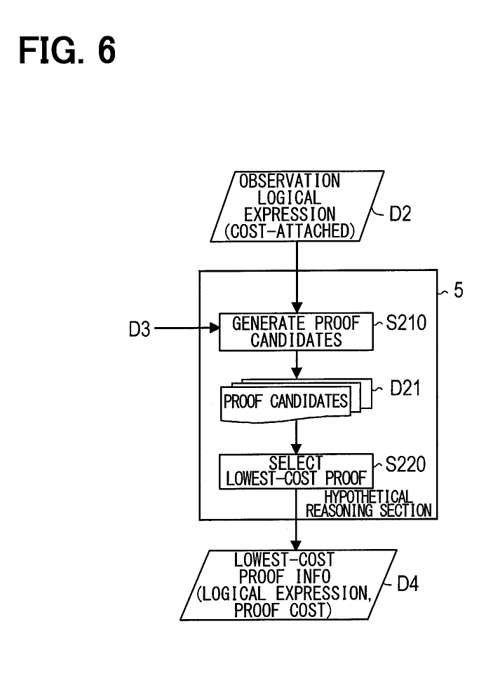

The hypothetical reasoning process will now be described in detail with reference to the flowchart of FIG. 6.

First of all, a microcomputer functioning as the hypothetical reasoning section 5 (hereinafter referred to as the “reasoning microcomputer”) generates, as a proof candidate, a logical expression that is obtained by combining the observation logical expression D2 and a literal indicating a “risk” through the use of the logic symbol “AND (Λ)”, and performs backward reasoning on the generated proof candidate to generate a plurality of proof candidates (S210).

More specifically, first of all, the rule of the risk factor knowledge base 43 is applied to a literal indicating a “risk” included in the first proof candidate to prepare a plurality of proof candidates. Here, “rule application” is to regard a certain literal forming a proof candidate as a target literal, extract the knowledge logical expression D3 having the target literal as the consequent part of the rule, and replace the target literal in the proof candidate with the antecedent part of the extracted knowledge logical expression D3. Further, a plurality of proof candidates are generated by repeatedly applying the rules of the intention estimation knowledge base 41 and natural law knowledge base 42 to any literals of the generated proof candidates. A set of the proof candidates generated in the above manner is hereinafter referred to as the proof candidate set D21.

Next, the proof cost of each proof candidate in the proof candidate set D21 is determined, then the lowest-cost proof, which is a proof candidate whose proof cost is the lowest, that is, the maximum-likelihood proof, is extracted, and the logical expression and proof cost concerning the lowest-cost proof are outputted as the lowest-cost proof information D4 (S220).

The proof cost is determined by calculating the total cost of all literals forming a proof candidate. When “rule application” is performed in this instance, a cost obtained by multiplying the cost ci of an unreplaced literal (to-be-replaced literal) by the weight wj given to a literal obtained upon replacement (replaced literal) is regarded as the cost of the replaced literal. If literals indicating the same predicate exist in the proof candidate, a literal whose cost is relatively high is deleted to achieve literal unification. That is, when the number of literals forming the proof candidate is increased upon rule application, the proof cost generally increases. However, if identical literals exist in the proof candidate, the proof cost may decrease in some cases. Intuitively, it signifies that the maximum-likelihood proof is provided by a rule in the risk factor knowledge base 43 that can be proved by using as many observation logical expressions as possible.

### 1.7. Example of Proof Candidate Generation

Let us assume that a set B of knowledge logical expressions D3, which are the rules used for proof, is expressed by Expression (2), and that a set 0 of literals forming an observation logical expression is expressed by Expression (3). The literals are represented by p (x), q (x), r (x), and s (x).

[Mathematical 2]

B={p(x)^{1.2}→q(x),(x)^{0.8} [symbol] r(x)^{0.4}→s(x)} (2)

O={q(a)^{$10},s(b)^{$10}} (3)

First of all, when the observation logical expression itself is regarded as a proof candidate H1 as indicated in Expression (4), the proof cost cost (H1) of the proof candidate H1 is determined by Expression (5).

[Mathematical 3]

H1={q(a)^{$10},s(b)^{$10}} (4)

cost(H1)=10+10=20 (5)

Next, when the rules are applied to a literal q (a) belonging to the proof candidate H1, a proof candidate H2 indicated in Expression (6) is generated. Here, it is assumed that deleting a to-be-replaced literal from the proof candidate H2 is achieved by setting the cost of the literal to $0. The proof cost cost (H2) of the proof candidate H2 is determined by Expression (7). It is obvious that the proof cost of the proof candidate H2 is higher than that of the proof candidate H1 due to rule application, that is, backward reasoning.

[Mathematical 4]

H2={q(a)^{$0},s(b)^{$10},p(a)^{$1.2·10 ̂$12}} (6)

cost(H2)=10+12=22 (7)

Next, when the rules are applied to a literal s (b) belonging to the proof candidate H2, a proof candidate H3 indicated in Expression (8) is generated. When the proof cost cost (H3) of the proof candidate H3 is calculated in a simple manner, the result of calculation is indicated in Expression (9).

[Mathematical 5]

H3={q(a)^{$0},s(b)^{$0},p(a)^{$12},p(b)^{$8},r(b)^{$4}} (8)

cost(H3)=12+8+4=24 (9)

However, as identical literals p (a), p (b) exist in the proof candidate H3, they are unified (a=b) to delete p (a) whose cost is relatively high. As a result, the proof candidate H3 is expressed by Expression (10). That is, the proof cost cost (H3) of the proof candidate H3 is actually determined by Expression (11) so that the proof cost is decreased by unification.

[Mathematical 6]

H3={q(a)^{$0},s(b)^{$0},p(b)^{$8},r(b)^{$4},a=b} (10)

cost(H3)=8+4=12 (11)

### 1.8. Reasoning Result Interpretation Section

Based on the lowest-cost proof information D4, the reasoning result interpretation section 6 references the observation logical expression D2 and the observed information associated with each literal forming the observation logical expression D2, identifies a risk predicted from the current surroundings, calculates a risk level of the identified risk, identifies the location of the risk, and outputs these items of information as a risk prediction result D5.

The risk can be identified from a rule in the risk factor knowledge base 43 that is used to generate the lowest-cost proof. The risk level can be determined from the proof cost. More specifically, the reciprocal of the proof cost may be determined as the risk level. Alternatively, the risk level may be determined, for example, by using a regression model whose feature amounts include a proof result, a proof cost, and the speed of the subject vehicle. The risk location may be identified by associating a literal forming the lowest-cost proof with an identifier given to a literal forming the observation logical expression D2 and using the position information about an object indicated by the observed information identified by the identifier.

### 1.9. Risk Handling Section

Based on the risk prediction result D5, the risk handling section 7 executes a risk handling process on a predicted risk. The risk handling process includes vehicle control and notifications to a vehicle driver. The vehicle control may include speed control, speed restriction, emergency stop, and automatic driving for risk avoidance. The notifications for drawing a driver's attention include an audible notification and a visible notification. The audible notification may include issuing a warning by sounding a buzzer or by generating an audible guidance message. The visible notification may include displaying a risk location within a map on a liquid-crystal display and using a windshield embedded display (head-up display) to display a risk location and direct the line of sight to the risk location. Further, based on the determined risk level of the predicted risk, the risk handling section 7 may vary the risk handling process to be executed.

### 1.10. Concrete Examples

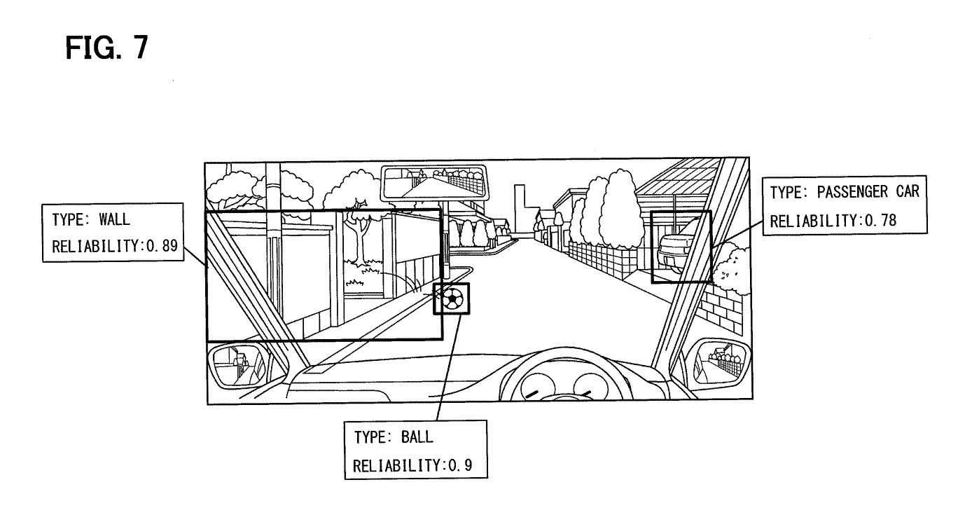

Operations of the driving support system 1 will now be described with reference to FIG. 7, which illustrates a scene that may be encountered during driving in a residential area.

Objects shown in the illustrated scene and targeted for the generation of observed information include a wall positioned to the left of a subject vehicle, a ball on a road, and a vehicle in a carport visible to the right of the subject vehicle. Observed information about the wall is generated to include “type: wall” and “reliability: 0.89”. Observed information about the ball is generated to include “type: ball” and “reliability: 0.9”. Observed information about the vehicle in the carport is generated to include “type: passenger car” and “reliability: 0.78”.

<Case 1>

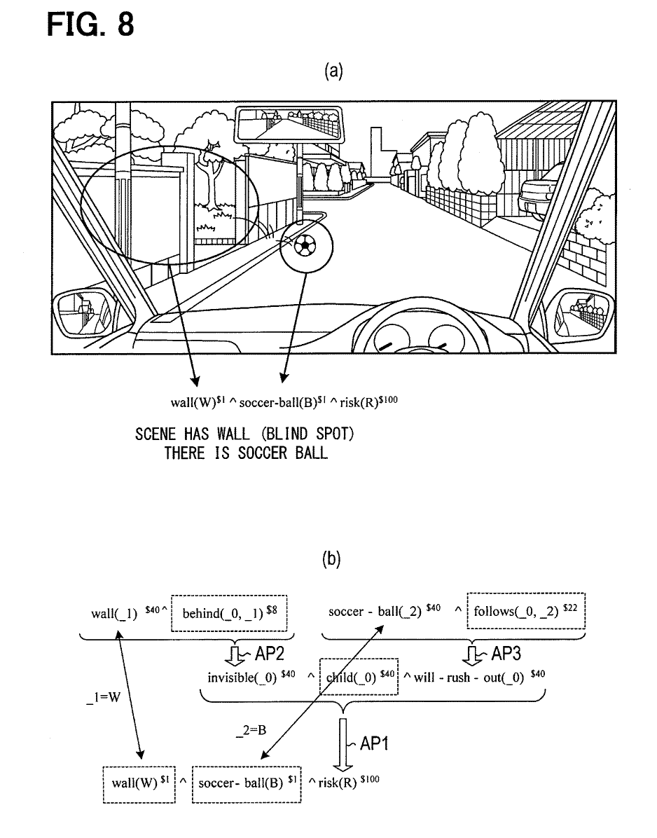

For the sake of brevity, the following describes a case where a risk arising when the observed information is merely about a “wall” and a “ball” as illustrated at FIG. 8(a) is to be predicted.

First of all, a logical constant serving as the identifier is given to each object. Here, it is assumed that W is given to the “wall” and that B is given to the “ball”.

Next, the observed information is converted to cost-attached observed literals. Here, the “wall” is converted to “wall(W)^{$1}”, and the “ball” is converted to “soccer-ball(B)^{$1}”. The costs of the observed literals are set by determining the reciprocal of reliability in the observed information. Here, for the sake of brevity, the costs of the observed literals are both set to $1.

Next, the above observed literals and “risk(R)^{$100}”, which is a literal indicating that “a risk R exists in a traffic scene”, are used to generate the proof candidate (first proof candidate) “wall(W)^{$1} Λ soccer ball(B)^{$1} Λ risk(R)^{$100}”. The cost of a literal indicating a risk is $100 because whether the risk exists is unknown.

Next, one of the rules in the risk factor knowledge base 43 is applied to the literal “risk(R)” of the first proof candidate as illustrated at FIG. 8(b). The rule applied here is “∀x invisible(x)^{0.4} Λ child(x)^{0.4} Λ will-rush-out(x)^{0.4}→∃r risk(r)” (see AP1 at FIG. 8(b)). The knowledge expressed by this rule is “there is a risk” because “x is invisible”, “x is a child”, and “x rushes out”, that is, “a child rushes out of a blind spot (created by a wall)”. When this rule is applied, the cost of each literal (replaced literal) forming the antecedent part of the rule is $40 (=$100×0.4). This is added as a new proof candidate (second proof candidate).

Next, the intention estimation knowledge base 41 and the natural law knowledge base 42 are searched for a rule whose consequent part is the replaced literal. If such a rule is found, that rule is applied to the replaced literal. Here, two rules, namely, “∀x, y wall(x)^{1.0} Λ behind(y, x)^{0.2}→invisible(y)” (see AP2 at FIG. 8(b)) and “∀x, y soccer-ball(x)^{1.0} Λ follows(y, x)^{0.55}→will-rush-out(y)” (see AP3 at FIG. 8(b)), are applied. The knowledge expressed by the former rule is “y is invisible” because “x is a wall” and “y is behind x”, that is, “y is behind a wall”. The knowledge expressed by the latter rule is “y rushes out” because “x is a soccer ball” and “y follows x”, that is, “y follows a soccer ball”. When these rules are applied, the costs of the replaced literals “wall(x)”, “behind(y, x)”, “soccer-ball(x)”, and “follows(y, x)” are $40 (=$40×1.0), $8 (=$40×0.2), $40 (=$40×1.0), and $22 (=$40×0.55), respectively. In this instance, the costs of the to-be-replaced literals “invisible(y)” and “will-rush-out(y)” are $0, which indicates that they are deleted. Further, as there are the same observed literals as the replaced literals “wall(x)” and “soccer-ball(x)” (see the directional lines at FIG. 8(b)), their costs are compared to delete a replaced literal having a higher cost. A case where only a rule having a consequent part of “invisible(y)” is applied is added as a third proof candidate. A case where only a rule having a consequent part of “will-rush-out(y)” is applied is added as a fourth proof candidate. A case where the above rules are both applied is added as a fifth proof candidate.

In reality, rule application is performed for replaced literals of the third to fifth proof candidates to generate a new proof candidate. For the sake of brevity, however, the generation of such a new proof candidate is not described here.

Next, the proof costs of the first to fifth proof candidates are determined. The determined proof costs of the first to fifth proof candidates are $102, $122, $90, $104, and $72, respectively. Consequently, the fifth proof candidate is the maximum-likelihood proof, and its risk level is calculated by using its proof cost. Further, the literals forming the fifth proof candidate and the observed information are associated with each other to determine the location of each object (wall and ball) and then identify the risk location.

<Case 2>

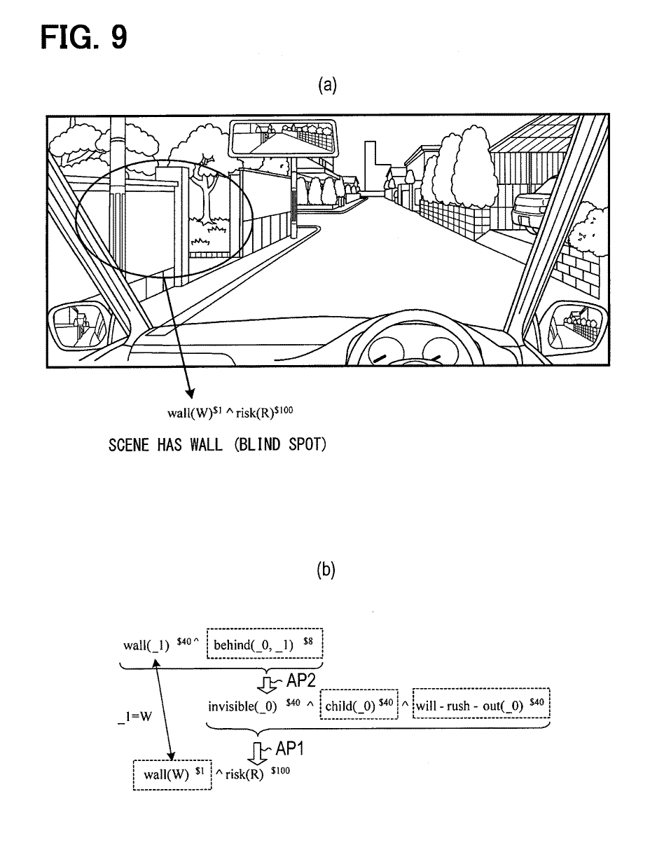

The following describes case 2 where the scene is similar to the one in case 1 except that no “ball” is observed, as illustrated at FIG. 9(a). More specifically, the observed information in case 2 is a “wall” only.

In case 2, backward reasoning is performed in the same manner as in case 1 to generate similar proof candidates. However, the literal “soccer-ball(x)” does not exist and no unification is performed for that literal as illustrated at FIG. 9(b). Therefore, the proof costs obtained in case 2 are different from those obtained in case 1. Here, the third proof candidate is the maximum-likelihood proof and its proof cost is $89. That is, the predicted risk factor is the same as in case 1; however, its risk level is a smaller value than in case 1. FIG. 9 does not illustrate an example in which a rule having a consequent part of “will-rush-out(y)” is applied because it entails a high proof cost.

<Case 3>

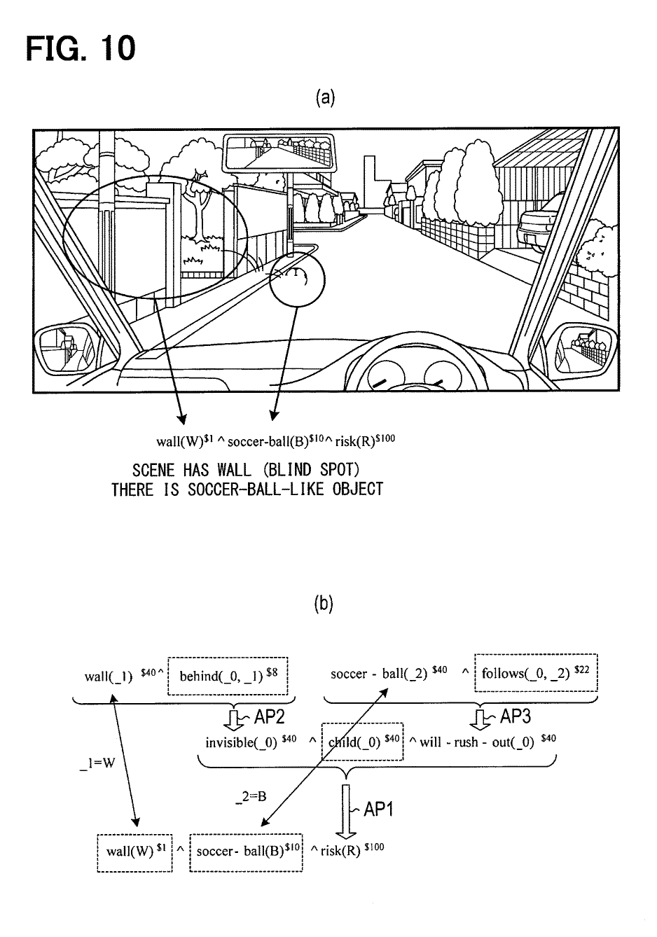

The following describes case 3 where the scene is similar to the one in case 1 except that the reliability of the observed information about a “ball” is low, as illustrated at FIG. 10(a). More specifically, the cost of a literal indicating the “ball” in case 3 is higher than in case 1.

In case 3, backward reasoning is performed in the same manner as in case 1 to generate similar proof candidates. However, the cost of the literal “soccer-ball(x)” is high as illustrated at FIG. 10(b). Therefore, the proof costs obtained in case 3 are different from those obtained in case 1. Here, the fifth proof candidate is the maximum-likelihood proof; however, its proof cost is $81 and different from case 1. That is, the predicted risk is the same as in cases 1 and 2; however, its risk level is a value smaller than in case 1 and greater than in case 2.

### 1.11. Advantageous Effects

As described above, when predicting a risk by hypothetical reasoning, the driving support system 1 does not simply check for a risk, but determines the proof cost from a cost based on observation reliability and a weight given in advance to each literal forming a knowledge rule and sets the risk level of a proved risk based on the determined proof cost.

That is, the reliability of an evidence (observation logical expression) and rules to be applied to a proof can be reflected in the risk level of a proved risk. Therefore, accurate risk prediction can be achieved based on the surroundings.

Further, the driving support system 1 provides driving support to cope with an accurately predicted risk. Therefore, highly reliable driving support can be achieved.

Moreover, the knowledge base 4 of the driving support system 1, which stores rules to be applied to proof, includes the intention estimation knowledge base 41 and the natural law knowledge base 42. Therefore, reasoning can be performed to estimate a risk caused by a person's intention and a risk caused by natural laws.

### 2. Second Embodiment

A second embodiment of the present disclosure has basically the same configuration as the first embodiment. Therefore, common elements will not be redundantly described. Differences between the first and second embodiments will be mainly described.

The first embodiment extracts only one proof of a risk factor having the highest risk level. The second embodiment differs from the first embodiment in that the former extracts proofs of a plurality of risk factors having a high risk level. More specifically, the first and second embodiments partly differ in the process executed by the hypothetical reasoning section.

### 2.1. Hypothetical Reasoning Section

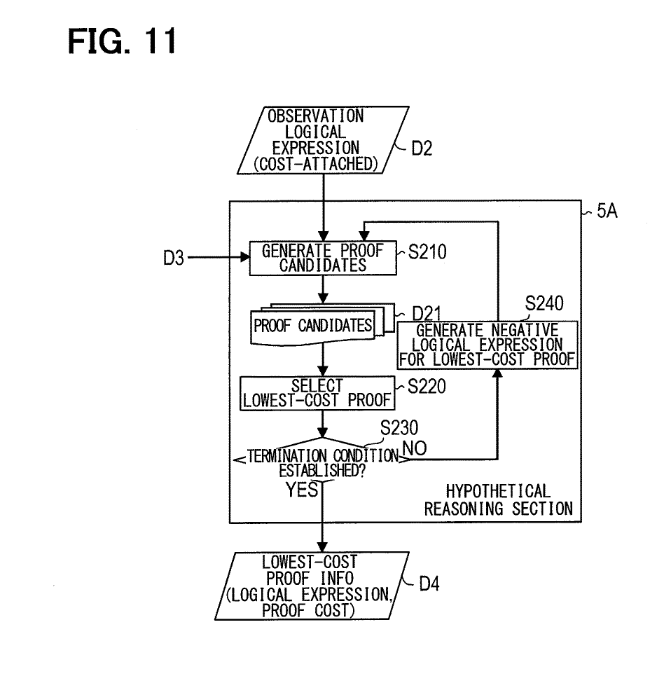

The process executed by a hypothetical reasoning section 5A will now be described with reference to the flowchart of FIG. 11.

A reasoning microcomputer functioning as the hypothetical reasoning section 5A first executes the same process as the hypothetical reasoning section 5 in the first embodiment (S210-S220).

Next, a check is performed to determine whether a predetermined termination condition for terminating the hypothetical reasoning process is established (S230). The predetermined termination condition may be established when, for example, a predetermined number of lowest-cost proofs are extracted, the proof cost of an extracted lowest-cost proof is equal to or higher than a threshold value, or all proof candidates are processed.

If the termination condition is established (S230: YES), the logical expression and proof cost of each proof selected in S220 are outputted.

If the termination condition is not established (S230: NO), a negative logical expression for the lowest-cost proof selected in S220 is generated (S240).

The generated negative logical expression is added to the observation logical expression in order to repeat the generation of proof candidates (S210) and the selection of the lowest-cost proof (S220).

### 2.2. Concrete Example

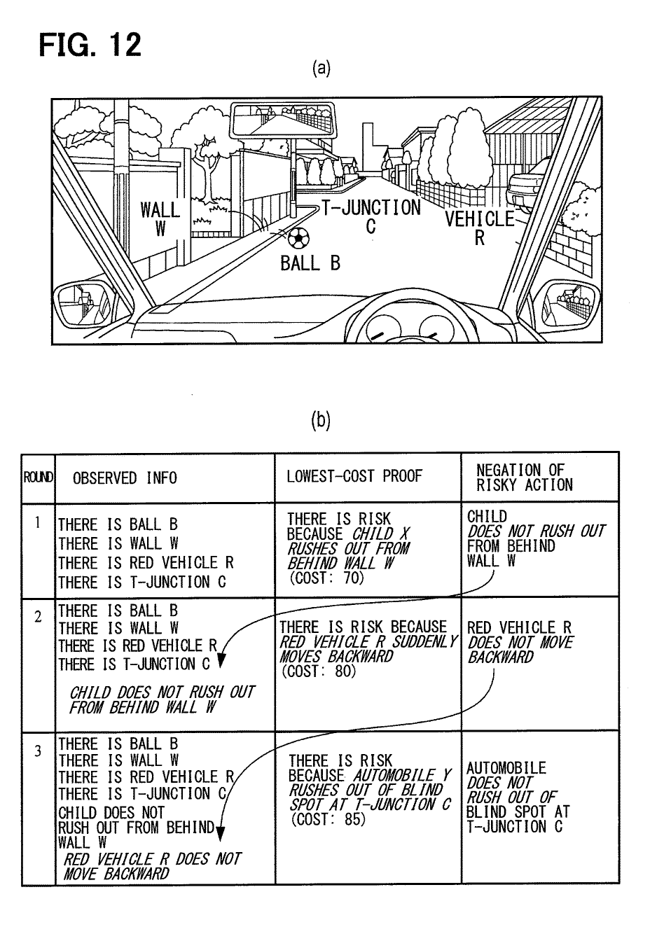

As illustrated at FIG. 12(a), it is assumed that the scene is the same as described with reference to FIG. 7. It is also assumed that the termination condition is established when three lowest-cost proofs are extracted.

As illustrated at FIG. 12(b), in the first round of hypothetical reasoning, an observation logical expression, which is formed of the literals “there is a ball B”, “there is a wall W”, “there is a red vehicle R”, and “there is a T junction C”, is generated, and the generated observation logical expression is used to generate proof candidates and select the lowest-cost proof. Here, the proof candidate “there is a risk because a child X rushes out from behind the wall W” is selected as the lowest-cost proof, and its proof cost is 70. At this point of time, the termination condition is not established because only one lowest-cost proof is extracted. Thus, “no child rushes out from behind the wall W” (first negative logical expression), which is a logical expression for negating the lowest-cost proof, is generated.

In the second round of hypothetical reasoning, the first negative logical expression is added to the observation logical expression used for the first hypothetical reasoning to generate proof candidates and select the lowest-cost proof. Here, the proof candidate “there is a risk because the red vehicle R suddenly moves backward” is selected as the lowest-cost proof and its proof cost is 80. At this point of time, the termination condition is not established because only two lowest-cost proofs are extracted. Thus, “the red vehicle R does not move backward” (second negative logical expression), which is a logical expression for negating the lowest-cost proof, is generated.

In the third round of hypothetical reasoning, the second negative logical expression is added to the observation logical expression used for the second hypothetical reasoning to generate proof candidates and select the lowest-cost proof. Here, the proof candidate “there is a risk because an automobile Y rushes out from a visual sensation of the T-junction C” is selected as the lowest-cost proof and its proof cost is 85. At this point of time, the termination condition is established because three lowest-cost proofs are extracted. Thus, the three lowest-cost proofs derived from two reasonings are outputted.

If the termination condition is still not established in the third round of reasoning, “no automobile does not rush out from the blind spot of the T-junction C” (third negative logical expression), which is a logical expression for negating the lowest-cost proof, is generated. Subsequently, the fourth and subsequent rounds of reasoning are performed in a similar manner to extract new lowest-cost proofs.

### 2.3. Advantageous Effects

As described above, the second embodiment excludes a selected lowest-cost proof from the proof candidates and repeatedly performs hypothetical reasoning to select a new lowest-cost proof. Therefore, a plurality of risks can be efficiently extracted in order from the lowest proof cost to the highest, that is, in order from the highest risk level to the lowest. Further, the result of such extraction can be used to implement a driving support process that simultaneously copes with a plurality of risks.

In general, the number of proof candidates is enormous. Therefore, it is not realistic to generate all proof candidates and extract proofs in order from the lowest cost to the highest. Meanwhile, a method of determining the maximum-likelihood proof at high speed is proposed (e.g., Naoya Inoue and Kentaro Inui, ILP-based Inference for Cost-based Abduction on First-order Predicate Logic, Journal of Natural Language Processing, Vol. 20, No. 5, pp. 629-656, December 2013, which is incorporated herein by reference). When this method is used, a plurality of proofs can be efficiently enumerated.

### 3. Third Embodiment

A third embodiment of the present disclosure has basically the same configuration as the first embodiment. Therefore, common elements will not be redundantly described. Differences between the first and third embodiments will be mainly described.

The first and second embodiments perform hypothetical reasoning based on an observation logical expression derived from observed information. However, the third embodiment differs from the first and second embodiments in that the former simulates the behavior of a movable object based on the contents of a selected lowest-cost proof and adds the result of simulation to the observation logical expression to repeatedly perform hypothetical reasoning. More specifically, the configuration of a hypothetical reasoning section 5B in the third embodiment is partly different from that of the counterparts in the first and second embodiments, and a physics calculation section 8 is newly added to the third embodiment.

### 3.1. Hypothetical Reasoning Section

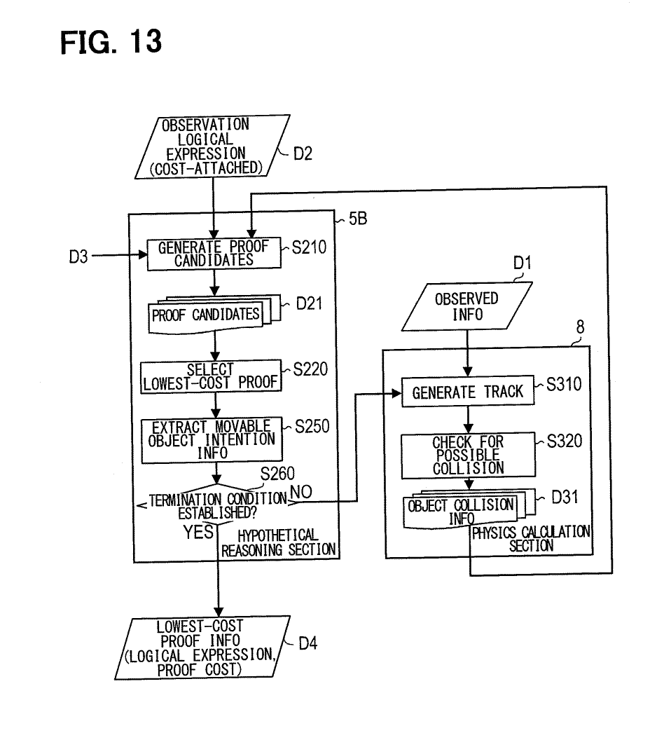

The process executed by the hypothetical reasoning section 5B will now be described with reference to the flowchart of FIG. 13.

A reasoning microcomputer functioning as the hypothetical reasoning section 5B first executes the same process as the hypothetical reasoning section 5 in the first embodiment (S210-S220).

Next, information about the intention of a movable object is extracted from a selected lowest-cost proof (S250). The information about the intention of a movable object includes “avoid”, “rush out”, and “slow down”.

Next, a check is performed to determine whether a predetermined termination condition for terminating the hypothetical reasoning process is established (S260). The predetermined termination condition may be established when, for example, the intention of a movable object extracted from the lowest-cost proof is the same as an intention previously determined by reasoning or a predetermined number of risks are extracted by repeating the hypothetical reasoning process in consideration of the result of simulation.

If the termination condition is established (S260: YES), the logical expression and proof cost of each proof selected in S220 are outputted.

If the termination condition is not established (S260: NO), the intention information about the intention of a movable object, which is extracted in S250, is delivered to the physics calculation section 8.

### 3.2. Physics Calculation Section

The physics calculation section 8 is implemented by the process executed by the microcomputer, as is the case with the hypothetical reasoning section 5B.

Upon receipt of the intention information from the hypothetical reasoning section 5B, a microcomputer functioning as the physics calculation section 8 (hereinafter referred to as the “physics calculation microcomputer”) determines the tracks of the subject vehicle and all objects based on information (position, speed, and moving direction) indicative of the behaviors of objects existing around the subject vehicle including the subject vehicle and movable objects targeted for intention information acquisition (S310).

Next, simulation is performed to determine based on the determined tracks whether the subject vehicle will collide with the objects, and then object collision information is generated (S320). The object collision information is formed of a logical expression indicative of the result of determination of each object. A set of the object collision information is referred to as the object collision information set D31. The object collision information set D31 is supplied to the hypothetical reasoning section 5B.

Upon receipt of the object collision information set D31 from the physics calculation section 8, the hypothetical reasoning section 5B adds the object collision information set D31 to the observation logical expression D2, and repeats the generation of proof candidates (S210), the selection of the lowest-cost proof (S220), and the extraction of movable object intention information (S260).

### 3.3. Concrete Examples

It is assumed that, in an encountered scene, a two-wheeled vehicle is traveling in front of the subject vehicle, and that a puddle is on the travel path of the two-wheeled vehicle.

<Scene 1>

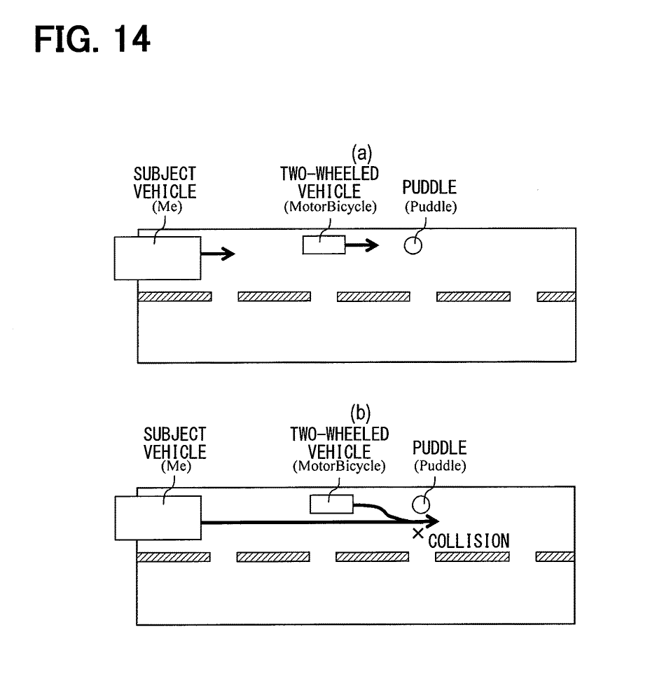

First of all, the following description deals with a case where the subject vehicle is close to the two-wheeled vehicle as illustrated at FIG. 14(a).

The hypothetical reasoning section 5B selects, as the lowest-cost proof, a proof that is the same as the one indicated by the observation logical expression. No intention is to be extracted from this lowest-cost proof.

Based on the observed information D1 about objects around the subject vehicle including the subject vehicle, the physics calculation section 8 determines the moving paths of the objects. As a result, it is predicted that the two-wheeled vehicle will collide with the puddle. Thus, object collision information is generated to indicate that “a two-wheeled vehicle (MotorBicycle) collides with a puddle (Puddle)”.

The hypothetical reasoning section 5B adds the object collision information generated by the physics calculation section 8 to the observation logical expression D2 and performs hypothetical reasoning again. As a result, the hypothetical reasoning section 5B selects, as the lowest-cost proof, “the two-wheeled vehicle (MotorBicycle) avoids the puddle (Puddle)”, and then extracts, from the lowest-cost proof, “the two-wheeled vehicle avoids the puddle” as the intention information.

Based on the extracted intention information and the observed information set D1 about the objects around the subject vehicle including the subject vehicle, the physics calculation section 8 determines the moving paths of the objects. Particularly, the physics calculation section 8 predicts the moving path of an object (the two-wheeled vehicle in the present case) targeted for intention information acquisition. Based on the determined moving paths, the physics calculation section 8 performs simulation to determine whether the subject vehicle will collide with a different object. In scene 1, it is predicted that the subject vehicle will collide with the two-wheeled vehicle as illustrated at FIG. 14(b). Therefore, the physics calculation section 8 generates the object collision information indicating that the “subject vehicle (Me) collides with the two-wheeled vehicle”. If there are objects (e.g., an oncoming vehicle, a parallel running vehicle, a second preceding vehicle, a roadside object, and a fallen object) other than the two-wheeled vehicle, simulation is also performed to determine whether the subject vehicle will collide with such objects and whether such objects will collide with each other.

The hypothetical reasoning section 5B adds the object collision information generated by the physics calculation section 8 to the observation logical expression D2 and performs hypothetical reasoning again. As a result, “there is a risk because the subject vehicle will collide with the two-wheeled vehicle” is selected as the lowest-cost proof. That is, risk prediction is performed in consideration of the result of simulation.

<Scene 2>

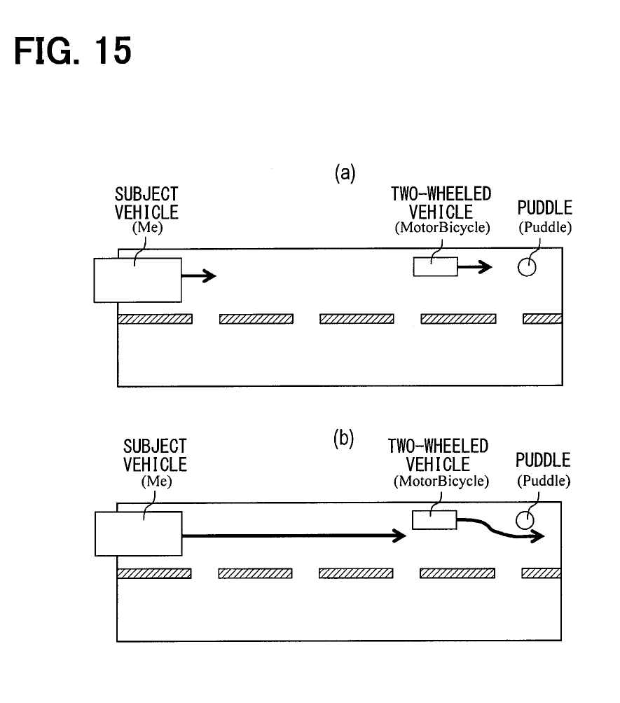

Next, the following description deals with a case where, as illustrated at FIG. 15(a), the subject vehicle is sufficiently apart from the two-wheeled vehicle as compared with the case in scene 1.

In the same manner as described in conjunction with scene 1, the hypothetical reasoning section 5B selects the lowest-cost proof to extract the intention information from the selected lowest-cost proof, and the physics calculation section 8 determines the moving paths of the objects based on the intention information in order to determine whether the subject vehicle will collide with a different vehicle.

In scene 2, as illustrated at FIG. 15(b), the result of simulation indicates that the subject vehicle will not collide with the two-wheeled vehicle. Therefore, the object collision information is generated to indicate that “the subject vehicle does not collide with the two-wheeled vehicle”.

The hypothetical reasoning section 5B adds the generated object collision information to the observation logical expression D2 and performs hypothetical reasoning again. As a result, the risk selected in scene 1 cannot be proved. Therefore, “the two-wheeled vehicle avoids the puddle”, which was the lowest-cost proof selected before the result of simulation was taken into consideration, is eventually selected as the lowest-cost proof.

### 3.4. Advantageous Effects

As described above, the third embodiment performs simulation based on the intention information and the observed information (e.g., position, speed, and moving direction) about objects, adds a collision determination result derived from the simulation to the observation logical expression D2, and repeats hypothetical reasoning.

Consequently, risk prediction is performed in consideration of the behavior of objects that is estimated based on information derived from initial hypothetical reasoning. Therefore, more accurate risk prediction can be achieved.

### 4. Alternative Embodiments

While the present disclosure has been described in conjunction with the foregoing embodiments, the present disclosure is not limited to the foregoing embodiments. It should be understood that the present disclosure may be implemented in various alternative embodiments.

(1) The functionality of an element in the foregoing embodiments may be dispersed among a plurality of elements, and the functions of a plurality of elements in the foregoing embodiments may be integrated into a single element. Further, at least a part of elements in the foregoing embodiments may be replaced by an element having the same functionality. Furthermore, a part of elements the foregoing embodiments may be omitted. Moreover, at least a part of elements in a foregoing embodiment may be added to or employed as a replacement of an element in another foregoing embodiment.

(2) The above-described embodiments are not only applicable to a risk prediction device, but also applicable to various systems such as a driving support system including the risk prediction device, a program for causing a computer to function as the risk prediction device, a medium for storage such a program, and a risk prediction method.

1. A risk prediction device comprising:
an observed information acquisition section that acquires observed information about surroundings of a vehicle;
a logical expression conversion section that converts the observed information acquired by the observed information acquisition section to a logical expression indicative of the surroundings of the vehicle;
a hypothetical reasoning section that, using a knowledge base, proves a risk predicted by weighted hypothetical reasoning from the logical expression obtained from conversion by the logical expression conversion section as a proof target, the knowledge base being a set of rules that are written in logical expression form to describe risks encountered during vehicle driving and general knowledge; and
a reasoning result interpretation section that determines a risk level of the proved risk from a proof cost determined during reasoning by the hypothetical reasoning section, and associates the logical expression used for proof with the observed information.

2. The risk prediction device according to claim 1, wherein
the hypothetical reasoning section varies, based on reliability of the observed information, the costs of logical expressions forming the rules in such a manner as to decrease the costs with an increase in the reliability, and regards the total cost of the logical expressions used for proof as the proof cost.

3. The risk prediction device according to claim 1, wherein
the hypothetical reasoning section extracts at least one proof in order from the lowest proof cost to the highest.

4. The risk prediction device according to claim 1, wherein
the hypothetical reasoning section extracts a lowest-cost proof, adds a logical expression negating the risk proved by the lowest-cost proof to the proof target, and repeats the hypothetical reasoning, the lowest-cost proof being a proof involving the lowest proof cost.

5. The risk prediction device according to claim 1, wherein
the hypothetical reasoning section not only extracts the lowest-cost proof involving the lowest proof cost, but also extracts a logical expression indicative of an intention of a movable object included in the lowest-cost proof, estimates behavior of the movable object based on contents of the logical expression, adds a logical expression indicative of the result of the estimation to the proof target, and repeats the hypothetical reasoning.

6. The risk prediction device according to claim 1, wherein
the knowledge base includes, as a rule concerning the general knowledge, a rule indicative of natural laws, such as physical laws.

7. The risk prediction device according to claim 1, wherein
the knowledge base includes, as a rule concerning the general knowledge, a rule indicating a relationship between
status of the vehicle and of a vehicle driver and
an intention of the vehicle driver that is estimated from the status.

8. A driving support system comprising:
the risk prediction device according to claim 1; and
a support execution device that executes a driving support process to cope with the risk proved by the risk prediction device.

9. The driving support system according to claim 8, wherein
the support execution device executes the driving support process by drawing a driver's attention in an audible or visible manner.

10. The driving support system according to claim 8, wherein
the support execution device executes the driving support process by exercising vehicle control.

11. The driving support system according to claim 1, wherein
the support execution device varies the driving support process based on the risk level determined by the reasoning result interpretation section.
